(19) United States
(12) Patent Application Publication
(10) Pub. No.: US 2014/0084588 A1
(43) Pub. Date: Mar. 27, 2014

(54) GAS BEARING SUPPORTED TURBOMACHINE WITH REDUCTION GEAR ASSEMBLY

(71) Applicants: Giridhari L. Agrawal, Simsbury, CT (US); Charles W. Buckley, West Hartford, CT (US)

(72) Inventors: Giridhari L. Agrawal, Simsbury, CT (US); Charles W. Buckley, West Hartford, CT (US)

(21) Appl. No.: 14/033,966

(22) Filed: Sep. 23, 2013

Related U.S. Application Data
(60) Provisional application No. 61/704,030, filed on Sep. 21, 2012.

(51) Int. Cl. H02K 7/18

(52) U.S. Cl. CPC H02K 7/1823
USPC 290/52

(57) ABSTRACT

A turbine-driven generator (i.e., a turbomachine) is provided for extracting energy and generating electrical power from a process gas. A turbine impeller mounted on a rotating shaft is rotatably disposed within a turbine housing for processing process gas flowing between an inlet and an outlet of the turbine. The rotating shaft of the turbine is coupled to a high-speed pinion of a reduction gear assembly to transfer torque from the turbine, via the gear assembly, to a generating device. Upon operation of the turbine impeller, rotation of the turbine rotating shaft, often at high speeds, is transferred to the high-speed pinion, which transfers torque to a low-speed gear of the gear assembly in engagement with the pinion. Rotation of the low-speed gear in turn causes a rotating assembly of the generating device to rotate, often at much lower speeds, which generates power that can be directed to an energy grid.

### CROSS-REFERENCE TO RELATED APPLICATION

This application claims the benefit of U.S. Provisional Application No. 61/704,030, filed Sep. 21, 2012, which is incorporated herein by reference.

### FIELD OF THE INVENTION

The present invention relates generally to turbomachinery, and more particularly to turbine-driven generators and alternators used to convert energy stored in a process gas into electrical energy.

### BACKGROUND OF THE INVENTION

Turbine-driven generating devices are a key piece of machinery in many different systems for generation of energy. A turbine converts stored energy in a process gas to mechanical energy. A generating device, such as a generator or an alternator, which is typically coupled to the turbine via a coupling shaft, converts the mechanical energy into electrical energy. The electrical energy is then supplied to a load. Such a turbomachine thus provides a means for converting energy stored in a process gas into electrical energy that is readily available to the user. These devices are especially useful for self-generation of electric energy and local power, and have long been employed in circumstances where power is not readily available from traditional sources, such as in remote locations.

This invention builds upon the work discussed in U.S. patent application Ser. No. 13/484,751, entitled “Mechanically Coupled, Very High Pressure Turbomachine Configurations for Waste Heat Recovery,” which is incorporated herein by reference. That application describes a turbomachine that comprises a turbine coupled with an alternator or generator running at high speeds, where the machine utilizes hydrodynamic foil bearings to accommodate operation at such high speeds. In the present invention, a turbine and a generator are coupled together via a high-speed reduction gear assembly, permitting a turbine to be coupled to a conventional bearing machine (e.g., utilizing ball, roller, or oil lubricated bearings) or gearbox without compromising performance or losing the efficiency or benefits of the turbomachine. This invention is new, since so far no foil bearing machine has been coupled to a conventional bearing machine or gearbox. Use of a gearbox permits aspects of the turbomachine (namely, the generating device) to run at reduced speeds compared to the high-speed operation of the turbine. For example in embodiments of a turbomachine in accordance with the present invention, the fundamental frequency of the generator is about 50/60 Hz. Running at such low speeds allows power generated by the turbomachine to go directly to an energy grid without the addition of grid connect power electronics.

In view of the foregoing, there is a need for a turbomachine that can utilize a high-pressure, high-sped turbine, and take advantage of the benefits provided by such a machine—i.e., high-speed operation, high efficiency, smaller machine size—with a low-speed generating device, and take advantage of the benefits provided by such a machine—i.e., optimal use of generated power. Accordingly, it is a general object of the present invention to provide a turbine-driven generator or alternator that overcomes the problems and drawbacks associated with use of such turbomachines at high pressures and high speeds without compromising the generation and capture of power.

### SUMMARY OF THE INVENTION

The present invention is generally directed to a turbomachine, and embodiments are especially adapted to turbine-driven designs, comprising a high-pressure turbine, reduction gear assembly and a low-speed generator or alternator adapted for recovery energy stored in a process gas.

The turbomachine of the present invention generally comprises two separate machines, specifically, a turbine device and a generator device operatively connected together by a gear assembly capable of transferring torque and rotating at respective speeds. In preferred embodiments of the turbomachine, the turbine device is capable of operation at high speeds, while the generator device operates at low speeds. The gear assembly ensures that each device can operate at it desired speed without affecting operation of the other machine or compromising the efficiency of the turbomachine to recover energy stored in a process gas.

In accordance with one embodiment of the present invention, a turbomachine is provided for extracting energy from a process gas, preferably a high-pressure process gas. The inventive turbomachine includes an impeller rotatably housed in a turbine housing for processing process gas flowing between an inlet and an outlet of the turbine housing; a generator housed in a generator housing; and a gear assembly connected between the turbine housing and the generator housing. The gear assembly preferably comprises a high-speed pinion coupled to a rotating shaft of the turbine impeller and a low speed gear coupled to a rotor assembly mounted for rotation in generator housing.

The turbomachine of the present invention, generally includes a turbine assembly, which includes a turbine housing, a rotating shaft mounted for rotation within the turbine housing, and an impeller rigidly attached to the rotating shaft for rotation therewith. The turbine housing has an inlet for receiving a process gas and has an outlet for discharging the process gas at a reduced pressure.

The rotating shaft of the turbine is supported for rotation about a longitudinal axis of the shaft. The shaft is radially supported by a pair of journal bearings. In preferred embodiments of the present invention, the turbine uses gas journal bearings, such as hydrodynamic foil bearings and hydrostatic bearings.

The turbine impeller, gas journal bearings and high-speed rotating shaft are located in the turbine housing, which is preferably sealed to contain the process gas used to drive the impeller. A shaft seal prevents process gas from leaking from the turbine housing to the environment.

The turbomachine of the present invention also includes a generator side, preferably designed for operation at a pressure and speed lower than in the turbine side of the turbomachine. The generator side of the turbomachine includes a generator housing; a stator assembly mounted in the generator housing; and a rotor assembly rotatably housed in the generator housing.

The high-speed rotating shaft is coupled to the high-speed pinion via a spline coupling to transfer torque thereto. The high-speed pinion is supported on conventional bearings such as ball, roller or oil-lubricated journal bearings. In operation, the high-speed pinion turns the low-speed gear which is also supported on conventional bearings. The low-speed gear is coupled to the generator using a low-speed coupling to transfer torque to the rotating assembly of the generator.

In a first aspect of the present invention, the rotating shaft of the turbine is axially supported by a thrust bearing assembly operatively connected with the rotating shaft. Preferably, the thrust bearing assembly comprises a pair of gas thrust bearings, such as hydrodynamic foil bearings or hydrostatic bearings.

In a second aspect of the present invention, a thrust bearing assembly is provided on the high-speed pinion. Preferably, the thrust bearing assembly comprises conventional bearings, such as ball, roller or oil-lubricated bearings.

These and other features of the present invention are described with reference to the drawings of exemplary embodiments of a bearing-supported turbomachine. The exemplary embodiments shown in the drawings are intended to illustrate, but not limit, the invention.

### BRIEF DESCRIPTION OF THE DRAWINGS

FIG. 1 shows a cross-sectional schematic view of a turbomachine in accordance with a first embodiment of the present invention.

FIG. 2 shows a cross-sectional schematic view of a turbomachine in accordance with a second embodiment of the present invention.

FIG. 3 shows a cross-sectional view of a generating device that may be used in a turbomachine in accordance with the present invention.

### DETAILED DESCRIPTION OF THE EMBODIMENTS OF THE INVENTION

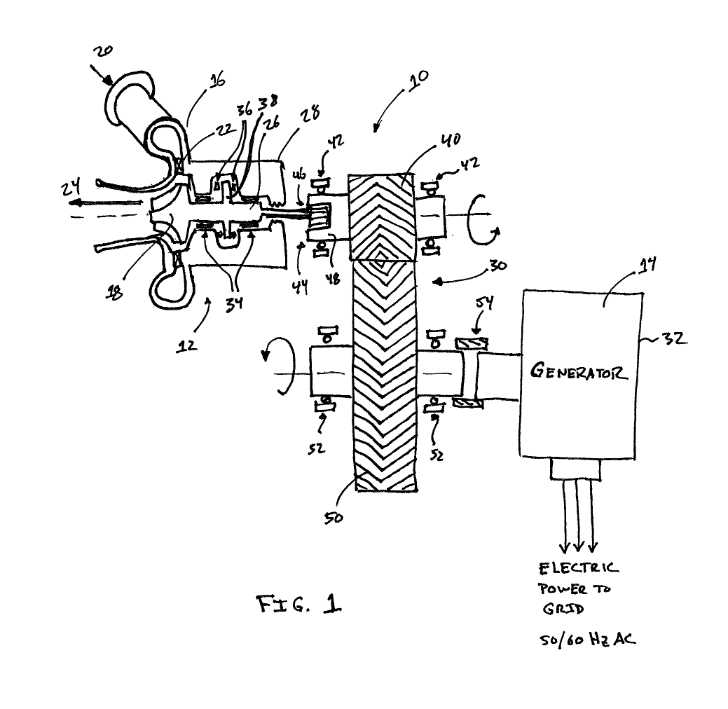

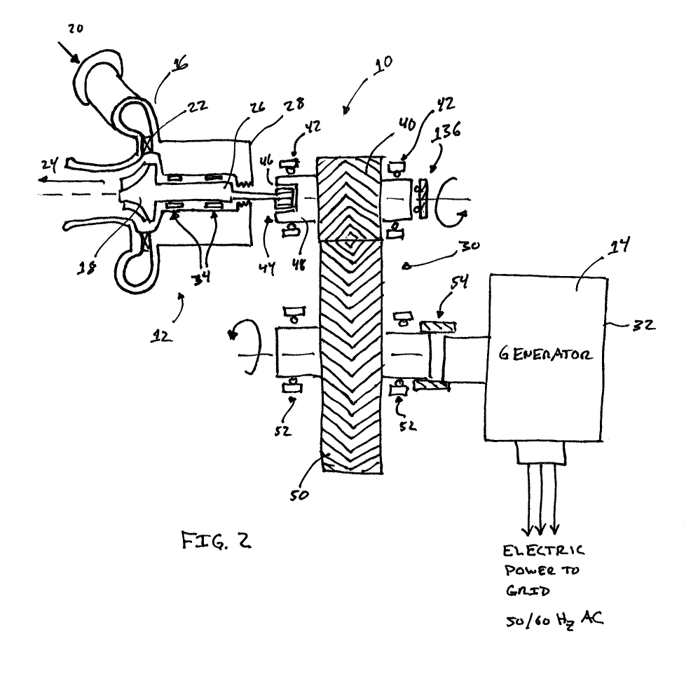

The present invention is directed to a power generating system for recovering energy stored in a process gas. Cross-sectional views of exemplary embodiments of turbine-driven generators in accordance with the present invention are illustrated in FIGS. 1 and 2, respectively.

Referring to FIG. 1, a turbomachine, generally designated by reference numeral 10, comprises a turbine 12 and a generating device 14, such as a generator or an alternator. In general, the turbomachine 10 of the present invention operates the same regardless of whether the generating device 14 is a generator or an alternator. Hereinafter, the generating device 14 is described with reference to a generator. However, this description equally applies to a device using an alternator as the generating device 14. The illustrated turbomachine 10—namely, a turbine-driven generator is preferably a small, high-efficiency device that can be used in various applications.

Referring to FIG. 1, the turbine 12 includes a turbine collector 16 defining an interior space within which an impeller or rotor 18 is rotatably mounted. A process gas enters the turbine 12 through an inlet 20, is directed through a fixed inlet nozzle 22 onto the blades of the impeller 18, and exits the turbine collector 16 via an outlet pipe 24. In general, high-pressure process gas passes through the turbine 12 between the inlet 20 and the outlet 24 and causes the impeller 18 to rotate about an axis of rotation. The nozzle 22 increases the kinetic energy of the process gas prior to moving through the impeller 18.

Upon rotation of the impeller 18, the turbine 12 converts mechanical energy to work of a rotating shaft 26 disposed within a turbine housing 28 for rotation about a central longitudinal axis. This work, in turn, is converted to electric power by the generator 14 of the turbomachine 10. In the present invention, and as described in more detail below, the turbine 12 is coupled to the generator 14 by a gear assembly 30 capable of transferring torque from the turbine 12 to the generator 14 while permitting the turbine 12 and the generator 14 to rotate at respective speeds. The gear assembly 30 allows the turbine to run at high speeds and the generator 14 to run at low speeds without the speed of one affecting the other and without the efficiency of the turbomachine 10 being compromised in any way. The electrical energy or power is withdrawn from the generator 14 through a power connector (not shown) that is provided on a generator housing 32. The electrical outlet of the power connector may provide power to any desirable machinery, power storage unit or the like. Generally, the power output is AC power. In the event that a DC output is desired, power can pass through additional power electronics, not shown but generally known to the person of ordinary skill in the art. The electrical power generated by the turbomachine 10 may be supplied to an energy grid.

The turbine impeller 18 is preferably a centrifugal type shrouded wheel made out of high-strength material with excellent corrosion and fatigue resistance. The turbine housing 28 is hermetically sealed to contain the process gas therein, and seals are used to restrict leakage of process gas from the turbine housing 28 and prevent contamination of the gear assembly 30 and generator 14 of the turbomachine 10. As shown in FIG. 1, a shaft seal 34 is provided in the turbine housing 28 around the rotating shaft 26 at the location where the shaft 26 extends out of the housing 28 to engage a high-speed pinion of the gear assembly 30 provided to transfer torque from the turbine 12 to a rotating assembly of the generator 14. Preferably, the material used for seals in the turbine 12 is a high performance polyimide-based material that has low wear, low friction, high strength, high chemical resistance, and excellent performance under extreme temperature conditions, high speeds and high operating pressures.

Referring again to FIG. 1, the rotating assembly of the turbine 12 comprises the impeller 18 mounted at one end of the rotating shaft 26. The shaft 26 is also radially supported within the turbine housing 28 by a pair of hydrodynamic or hydrostatic journal bearings 34, and axially supported by a pair of hydrodynamic or hydrostatic thrust bearings 36. As shown, a thrust runner 38 is disposed on or integral with the rotating shaft 26 for rotation therewith, with each of the thrust bearings 36 being disposed on a respective axial face of the thrust runner 38.

In order to maintain and operate the generator 14 at low pressure and lower speeds than the turbine 12, as is desired, the generator 14 of the present invention is isolated from the turbine 12 via the gear assembly 30. In operation of the turbomachine 10 of the present invention, the turbine rotating assembly is preferably driven by rotation of the impeller 18 about its axis of rotation as the process gas passes between the inlet 20 and the outlet 24. Shaft rotation, generally in the range of 15,000 to 40,000 rpm, effects operation of the generator 14 via the gear assembly 30. More particularly, torque is transmitted from the turbine shaft 26 to a high-speed pinion 40 mounted for rotation about a generally common axis of rotation to the rotating shaft 26 of the turbine 12. As shown in FIG. 1, the high-speed pinion 40 is supported by bearings 42, preferably conventional bearings such as ball, roller or oil-lubricated bearings.

The rotating shaft 26 of the turbine 12 is coupled to the high-speed pinion 40 via a coupling 44 that is designed to withstand high lateral and torsional loads, while at the same time being compliant enough to accommodate any misalignments between the turbine rotating shaft 26 and the high-speed pinion 40. An exemplary design of the coupling 44 is shown in FIG. 1. For example, a forward end 46 of the rotating shaft 26 has splines that slide axially into a complementary-shaped female splined cup-shaped portion 48 on the high-speed pinion 40. The teeth of the splines are coated with dry film lube to minimize friction between the mating teeth. This prevents thrust load transmission from the turbine 12 to the high-speed pinion 40 due to splines locking.

The high-speed pinion 40 includes a plurality of teeth that engage a low-speed gear assembly 50 mounted for rotation about its own axis. As shown in FIG. 1, the axis of rotation for the low-speed gear 50 is generally aligned with the axis of rotation for a rotating assembly of the generator 14. In operation, rotation of the high-speed pinion 40—as effected by the turbine 12—transfers torque to the low-speed gear 50. In turn, rotation of the low-speed gear 50 transfers torque to the rotating assembly of the generator 14. The respective arrangement of the teeth on the high-speed pinion 40 and the low-speed gear 50 form a reduction gear assembly 30 that permits each of the turbine 12 and the generator 14 to operate at respective speeds without affecting operation and efficiency of the turbomachine 10. As a result, operation of the turbine 14 at very high speeds effects operation of the generator 14, which operates at much lower speeds, to convert energy stored in a process gas into electrical energy. As the generator 14 operates at desirable low speeds, the power generated by the generator 14 can go directly to an energy grid without needing additional components, such as grid connect power electronics.

The low-speed gear 50 is supported for rotation by bearings 52, preferably conventional bearings such as ball, roller or oil-lubricated bearings. A low-speed coupling 54 is used to connect the low-speed gear 50 with the rotating assembly of the generator 14, as is schematically illustrated in FIG. 1.

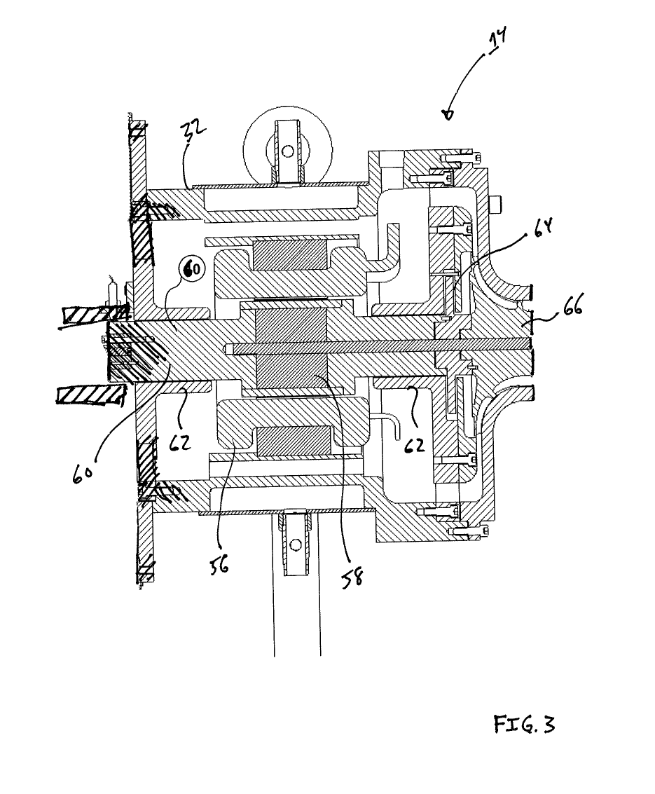

The generator 14 can have a conventional design as known to one of ordinary skill in the art. Referring to FIG. 3, for example, the generator 14 may include the generator housing 32, a stator assembly 56 and a permanent magnet (PM) rotor assembly 58 mounted on or integrated with a rotating shaft assembly 60 of the generator 14. In such a set-up, the rotating shaft assembly 60 is supported within the stator assembly 56 and the generator housing 32 on two journal bearing assemblies 62 and on a thrust bearing assembly 64, where the various bearing assemblies are cooled and supplied with air by a cooling fan 66, which is rigidly attached to one end of the rotating shaft assembly 60. The stator assembly 56 is press fitted into the inside diameter of the generator housing 32 for alignment with the rotor assembly 58 such that rotation of the rotor assembly 58 interacts with the stator assembly 56 to generate energy.

In operation of the present invention, rotation of the turbine shaft 26 causes the high-speed pinion 40 to rotate about an axis of rotation via the high-speed coupling 44. Rotation of the high-speed pinion 40 transfers torque to the low-speed gear 50. Rotation of the low-speed gear 50 causes the rotating shaft assembly 60 of the generator 14 to rotate about an axis of rotation via the low-speed coupling 54. Accordingly, use of the gear assembly 30 between the turbine 12 and the generator 14 permits the generator 14 to run at reduced speed where the fundamental frequency of the generator 14 is about 50/60 Hz. Running at such low speeds allows power generated by the turbomachine to go directly to an electric power grid without the addition of grid connect power electronics, as are commonly required for turboalternators and turbogenerators running at high speeds.

In an alternate embodiment of the present invention, as shown in FIG. 2, the turbine rotating shaft 26 is axially supported within the turbine housing 28 by a pair of journal bearing assemblies 34, preferably using hydrodynamic or hydrostatic journal bearings, and the high-speed pinion 40, which is coupled to the turbine 12 via coupling 44 connected to the rotating shaft 26 of the turbine 12, is supported for rotation by conventional bearings 42, such as ball, roller or oil-lubricated bearings, as is generally consistent with the embodiment illustrated in FIG. 1. The turbine 12 of FIG. 2, however, does not include a thrust bearing assembly within the turbine housing 28. Instead, a thrust bearing assembly 136 is provided at the end of the high-speed pinion 40, as illustrated in FIG. 2, for radially supporting the coupled turbine rotating assembly and high-speed pinion collectively. The thrust bearing assembly 136 may comprise conventional bearings as well.

Accordingly, to improve the thrust load capacity of the turbine 12, the present invention can use hydrodynamic foil gas thrust bearings or hydrostatic thrust bearings to support the turbine rotating shaft axially (FIG. 1), or use conventional bearing located at the end of the high-speed pinion 40 (FIG. 2). A combination of such thrust bearings can also be used without departing from the spirit and principles of the present invention.

Another variation of the inventive turbomachine of the present invention may use magnetic thrust bearings in combination with hydrodynamic foil gas journal bearings or hydrostatic journal bearings on the turbine. Use of magnetic thrust bearings increases the thrust load capacity significantly thus enabling the turbomachine scaling for multi mega watt systems.

The foregoing description of embodiments of the invention has been presented for the purpose of illustration and description. It is not intended to be exhaustive or to limit the invention to the form disclosed. Obvious modifications and variations are possible in light of the above disclosure. The embodiments described were chosen to best illustrate the principles of the invention and practical applications thereof to enable one of ordinary skill in the art to utilize the invention in various embodiments and with various modifications as suited to the particular use contemplated. It is intended that the scope of the invention be defined by the claims appended hereto.

What is claimed is:

1. A turbomachine for extracting energy from a process gas, said turbomachine comprising:
a turbine comprising a turbine impeller rotatably housed in a turbine housing for processing process gas flowing between an inlet and an outlet of the turbine housing, said turbine impeller being mounted on a rotating shaft disposed within the turbine housing for rotation about a central longitudinal axis;
a generator device housed in a generator housing, said generator device including a stator assembly mounted in the generator housing and a rotor assembly mounted for rotation in the generator housing relative to the stator assembly; and
a gear assembly connected between the turbine and the generator device coupling housed in the adapter housing and joining the rotating shaft associated with the turbine impeller to the rotor assembly of the generator device to transfer torque from the turbine to the generator device.

2. The turbomachine according to claim 1, wherein the gear assembly comprises:
a high-speed pinion coupled to the rotating shaft of the turbine; and
a low-speed gear coupled to the rotor assembly of the generator device.

3. The turbomachine according to claim 2, wherein the rotating shaft of the turbine is coupled to the high-speed pinion via a spline coupling.

4. The turbomachine according to claim 2, wherein the rotating shaft of the turbine is radially supported by a pair of journal bearings.

5. The turbomachine according to claim 4, wherein the rotating shaft of the turbine is axially supported by a pair of thrust bearings, being disposed on opposite axial faces of a thrust runner disposed on the rotating shaft for rotation therewith.

6. The turbomachine according to claim 5, wherein the journal and thrust bearings are hydrodynamic foil bearings.

7. The turbomachine according to claim 5, wherein the journal and thrust bearings are hydrostatic bearings.

8. The turbomachine according to claim 5, wherein the journal bearings are hydrodynamic foil bearings and the thrust bearings are hydrostatic bearings.

9. The turbomachine according to claim 4, wherein the rotating shaft of the turbine and the high-speed pinion are collectively axially supported by a thrust bearing assembly provided at the end of the high-speed pinion distal from the coupling between the high-speed pinion and the turbine rotating shaft.

10. The turbomachine according to claim 9, wherein the journal bearings are hydrodynamic foil bearings and the thrust bearing assembly comprises one of ball, roller or oil-lubricated bearings.

11. The turbomachine according to claim 9, wherein the journal bearings are hydrostatic bearings and the thrust bearing assembly comprises one of ball, roller or oil-lubricated bearings.

12. A turbomachine for extracting energy from a process gas, said turbomachine comprising:
a turbine comprising a turbine impeller rotatably housed in a turbine housing for processing process gas flowing between an inlet and an outlet of the turbine housing, said turbine impeller being mounted on a rotating shaft disposed within the turbine housing for rotation about a central longitudinal axis, said rotating shaft being radially supported by a pair of gas journal bearings and axially supported by a pair of gas thrust bearings;
a generator device housed in a generator housing, said generator device including a stator assembly mounted in the generator housing and a rotor assembly mounted for rotation in the generator housing relative to the stator assembly; and
a gear assembly connected between the turbine and the generator device coupling housed in the adapter housing and joining the rotating shaft associated with the turbine impeller to the rotor assembly of the generator device to transfer torque from the turbine to the generator device, said gear assembly comprising:
a high-speed pinion coupled to the rotating shaft of the turbine; and
a low-speed gear coupled to the rotor assembly of the generator device.

13. The turbomachine according to claim 12, wherein the gas thrust bearings are hydrodynamic foil bearings.

14. The turbomachine according to claim 12, wherein the gas thrust bearings are hydrostatic bearings.

15. The turbomachine according to claim 12, wherein the turbine includes a thrust runner disposed on the rotating shaft for rotation therewith and the pair of gas thrust bearings are disposed on opposing axial faces of said thrust runner.

16. A turbomachine for extracting energy from a process gas, said turbomachine comprising:
a turbine comprising a turbine impeller rotatably housed in a turbine housing for processing process gas flowing between an inlet and an outlet of the turbine housing, said turbine impeller being mounted on a rotating shaft disposed within the turbine housing for rotation about a central longitudinal axis, said rotating shaft being radially supported by a pair of gas journal bearings;
a generator device housed in a generator housing, said generator device including a stator assembly mounted in the generator housing and a rotor assembly mounted for rotation in the generator housing relative to the stator assembly; and
a gear assembly connected between the turbine and the generator device coupling housed in the adapter housing and joining the rotating shaft associated with the turbine impeller to the rotor assembly of the generator device to transfer torque from the turbine to the generator device, said gear assembly comprising:
a high-speed pinion coupled to the rotating shaft of the turbine; and
a low-speed gear coupled to the rotor assembly of the generator device;
wherein the rotating shaft of the turbine and the high-speed pinion are collectively axially supported by a thrust bearing assembly provided at the end of the high-speed pinion distal from the coupling between the high-speed pinion and the turbine rotating shaft.

17. The turbomachine according to claim 16, wherein the thrust bearing assembly comprises one of ball, roller or oil-lubricated bearings.
